(19) United States
(12) Patent Application Publication
(10) Pub. No.: US 2015/0155561 A1
(43) Pub. Date: Jun. 4, 2015

(54) ANODE AND LITHIUM BATTERY INCLUDING THE SAME

(71) Applicant: Samsung Electronics Co., Ltd., Suwon-si (KR)

(72) Inventors: Gue-sung KIM, Yongin-si (KR); Sang-kook MAH, Seoul (KR); Woon-jung PAEK, Hwaseong-si (KR); Myung-jin LEE, Seoul (KR)

(21) Appl. No.: 14/330,144

(22) Filed: Jul. 14, 2014

(30) Foreign Application Priority Data
Nov. 29, 2013 (KR) 10-2013-0147991

(51) Int. Cl. H01M 4/62; H01M 4/134; H01M 10/052; H01M 4/1395; H01M 4/04; H01M 4/133; H01M 4/1393

(52) U.S. Cl. CPC H01M 4/62; H01M 4/133; H01M 4/134; H01M 4/1393; H01M 4/1395; H01M 4/0404; H01M 4/0402; H01M 10/052; H01M 2004/027

(57) ABSTRACT

An anode including a current collector; an anode active material layer disposed on the current collector, and a lithium-containing organic compound disposed on a surface of the anode active material layer

### RELATED APPLICATIONS

This application claims priority to and the benefit of Korean Patent Application No. 10-2013-0147991, filed on Nov. 29, 2013, in the Korean Intellectual Property Office, and all the benefits accruing therefrom under 35 U.S.C. §119, the content of which is incorporated herein in its entirety by reference.

### BACKGROUND

1. Field

The present disclosure relates to anodes and lithium batteries including the same, and more particularly, to anodes having improved initial efficiency and cycle lifetime characteristics and lithium batteries including the same.

2. Description of the Related Art

Lithium metal has been used as an anode active material for lithium batteries. However, when using lithium metal, there is a risk of explosion since short circuits occur due to the formation of dendrites. Thus, carbonaceous materials, instead of lithium metal, are frequently used as the anode active material in secondary batteries.

Examples of the carbonaceous materials may include crystalline carbons such as graphite and artificial graphite, and amorphous carbons such as soft carbon and hard carbon. Although the amorphous carbons have large capacities, they have high irreversibility during the charge/discharge process. Although graphite is representatively used as a crystalline carbon and has a high theoretical capacity of about 372 mAh/g, there is a limitation in using the graphite in high-capacity lithium batteries.

Metal-based or intermetallic compound-based anode active materials are being studied presently. For instance, lithium batteries utilizing metals or semimetals such as aluminum, germanium, silicon, tin, zinc and lead as anode active material are being studied. These materials are considered to be able to provide batteries having high capacities and high energy densities since such materials may perform intercalation and deintercalation of more lithium ions than those of anode active materials using carbonaceous materials, while maintaining high capacity and high energy density. For instance, pure silicon is known to have a high theoretical capacity of about 4,017 mAh/g.

However, when inorganic particles of silicon or tin are used as the anode active materials, cycle lifetime characteristics of the batteries including such inorganic particles decreases more than those of batteries including the carbonaceous materials since conductivities are reduced between active materials due to volume changes of the particles during the charge/discharge process, or phenomena occur such that the anode active materials are delaminated from an anode current collector. That is, inorganic particles such as silicon or tin may perform intercalation of lithium during charging of the battery so that the volumes are expanded as much as about 300% to about 400%. On the other hand, when lithium is subjected to deintercalation during discharge, lifetime characteristics may be rapidly reduced since the inorganic particles contract, and since electrical insulation may occur due to empty spaces formed between the active materials if such charging-discharging cycles are repeated.

While not wanting to be bound by theory, it is understood that batteries having anode active materials formed of composite materials such as silicon-carbon and tin-carbon that are frequently being studied as high-capacity anode active materials may have low coulombic efficiency because (1) large-scale irreversible reactions are generated during charge/discharge processes due to carbon defects and specific surface areas markedly increased in composite forming process, and (2) bonds between the active materials are weakened by severe expansion or contraction of the active materials.

Thus the remains a need for an improved anode, and a method of manufacturing the same.

### SUMMARY

Provided is an anode having improved initial efficiency characteristics and improved cycle lifetime characteristics.

Provided is a method of manufacturing the anode.

Provides is a lithium battery including the anode.

Additional aspects will be set forth in part in the description which follows and, in part, will be apparent from the description, or may be learned by practice of the presented embodiments.

According to an aspect, an anode includes a current collector; an anode active material layer disposed on the current collector; and a lithium-containing organic compound disposed on a surface of the anode active material layer.

According to an embodiment, the lithium-containing organic compound may include one or more organic compounds selected from polyacrylic acid, polyvinyl alcohol, polymethyl methacrylate, and polyethylene glycol.

According to another embodiment, the lithium-containing organic compound may form a film on the anode active material layer.

According to another aspect, a method of manufacturing an anode includes: mixing an anode active material, a conductive material, a binder, and a first solvent to prepare an anode active material mixture; applying the anode active material mixture onto a current collector to form an anode active material layer; applying a surface-treating mixture onto the anode active material layer, and then drying the anode active material layer under a vacuum, wherein the surface-treating mixture includes a lithium-containing organic compound and a second solvent.

According to an embodiment, the surface-treating mixture may contain about 0.01% by weight to about 20% by weight of the lithium-containing organic compound.

According to another aspect, a lithium battery includes a cathode, an anode, and an electrolyte, wherein the anode is the above-described anode.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic diagram illustrating a method of manufacturing an anode, according to an embodiment of the present disclosure.

### DETAILED DESCRIPTION

Reference will now be made in detail to embodiments, examples of which are illustrated in the accompanying drawing. In this regard, the present embodiments may have different forms and should not be construed as being limited to the descriptions set forth herein. Accordingly, the embodiments are merely described below, by referring to the figure, to explain aspects of the present description.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer, or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments will be described in further detail.

An anode according to an embodiment includes: a current collector; an anode active material layer disposed on, e.g., formed on, the current collector; and lithium-containing organic compound disposed on a surface of the anode active material layer. In an embodiment the lithium-containing organic compound may be provided by surface-treating with the lithium-containing organic compound.

While not wanting to be done by theory, it is understood that the anode including the anode active material layer that is surface-treated with the lithium-containing organic compound may improve initial efficiencies and cycle life characteristics of batteries by enabling the lithium-containing organic compound to suppress side reactions of an anode active material and an electrolyte and improving binding strength between anode active material particles.

Specifically, lithium in the lithium-containing organic compound may complement the conductivity of an anode active material so that initial efficiencies of batteries are improved. Further, an organic compound in the lithium containing organic compound may elastically receive expansion of the anode active material during charging or discharging of batteries so that cycle lifetime characteristics of batteries are improved. The anode active material layer may be surface-treated with the lithium-containing organic compound, and includes an embodiment in which the lithium-containing organic compound forms a film on an inner surface of a porous structure of the anode active material layer as well as on an outer surface of the anode active material layer. As described above, the lithium-containing organic compound may suppress side reactions of the anode active material and the electrolyte by forming a film on the surface of the anode active material layer, and may improve binding strength between the anode active material particles by forming a film on the inside of the porous structure of the anode active material layer.

The current collector may comprise any suitable material, and may be available in the form of a thin film or a foil. Examples of the current collector included in the anode may include a copper current collector.

The lithium-containing organic compound may include at least one organic compound selected from polyacrylic acid, polystyrene sulfonic acid, polyvinyl phosphonic acid, polyglutamic acid, polymethacrylic acid, polymethyl methacrylic acid, polycarboxylic acid, polyvinyl alcohol, polymethyl methacrylate, polyethylene glycol, and a hydrocarbon-based polymer or an acryl-based hydrophilic polymer including acidic groups or hydrophilic functional groups, such as —COOH, —SO₃H, —PO₃H, and —OH.

The lithium-containing organic compound may be contained in an amount from about 0.0001% by weight to about 3%, specifically about 0.001% by weight to about 1%, more specifically about 0.01% by weight to about 0.5% by weight, based on a total weight of the anode active material layer. When lithium containing organic compound is contained within the foregoing range, batteries may have improved initial efficiency and cycle lifetime characteristics.

Lithium and an organic compound in the lithium-containing organic compound may comprise ionic bonds between lithium cations and anions of an end group of the organic compound. For instance, lithium cations of a lithium compound and anions of the end group of the above-described organic compound may be present in a form where they are bonded to each other.

The anode active material layer may include an anode active material, a conductive material, and a binder.

Examples of the anode active material may include a metal-based anode active material, a carbonaceous anode active material, or a composite anode active material. The carbonaceous anode active materials may include at least one carbon selected from graphite, natural graphite, artificial graphite, soft carbon and hard carbon, and the metal-based anode active materials may include at least one metal selected from Si, Sn, Al, Ge, Pb, Zn, Ag, and Au, or alloys thereof. A method of preparing the composite anode active materials may include mixing the carbonaceous anode active materials and the metal-based anode active materials, then subjecting the carbonaceous anode active materials and the metal-based anode active materials to a mechanical treatment such as ball milling to form a mixture, and additionally performing a process such as a heat treatment if desired. Examples of the composite anode active material may include a silicon-carbon composite (i.e., a composite comprising silica and carbon) or a tin-carbon composite (i.e., a composite comprising tin and carbon).

Examples of the conductive material may include carbon black, and examples of the binder may include at least one selected from vinylidene fluoride/hexafluoropropylene copolymer, polyvinylidene fluoride (“PVDF”), polyacrylonitrile, polymethyl methacrylate, polytetrafluoroethylene, and styrene butadiene rubber-based polymers. A combination of the foregoing may be used.

The lithium-containing organic compound may contain lithium in an amount from about 0.01% by weight to about 20%, specifically about 0.1% by weight to about 10%, more specifically about 1% by weight to about 5% by weight, based on total weight of the lithium containing organic compound. When lithium is contained within the foregoing range, batteries may have improved initial efficiencies.

The anode according to the embodiment may be particularly effective when the anode active materials are expanded to a volume of about 10% or more, specifically about 1% to about 100%, more specifically about 2% to about 50% during charging of batteries.

A method of manufacturing an anode, according to an embodiment, includes mixing an anode active material, a conductive material, a binder, and a first solvent to prepare an anode active material mixture; applying the anode active material mixture onto a current collector to form an anode active material layer; applying a surface-treating mixture onto the anode active material layer, and then drying the anode active material layer under vacuum, wherein the surface-treating mixture includes a lithium-containing organic compound and a second solvent.

The first solvent is included in the anode active material mixture, and the second solvent is included in the surface-treating mixture. The first solvent and a second solvent may be the same or different. The surface-treating mixture may be prepared by dissolving the lithium compound and the organic compound into the second solvent. Examples of the lithium compound may include at least one of lithium hydroxide, lithium carbonate, lithium nitrate, and lithium phosphate. Examples of the organic compound may include at least one of polyacrylic acid, polyvinyl alcohol, polymethyl methacrylate, and polyethylene glycol. The lithium compound may be included in such an amount that lithium is contained in the lithium-containing organic compound in an amount from about 0.1% by weight to about 10% by weight, specifically about 0.5% to about 5% by weight more specifically about 1% to about 3% by weight, based on a total weight of the lithium-containing organic compound.

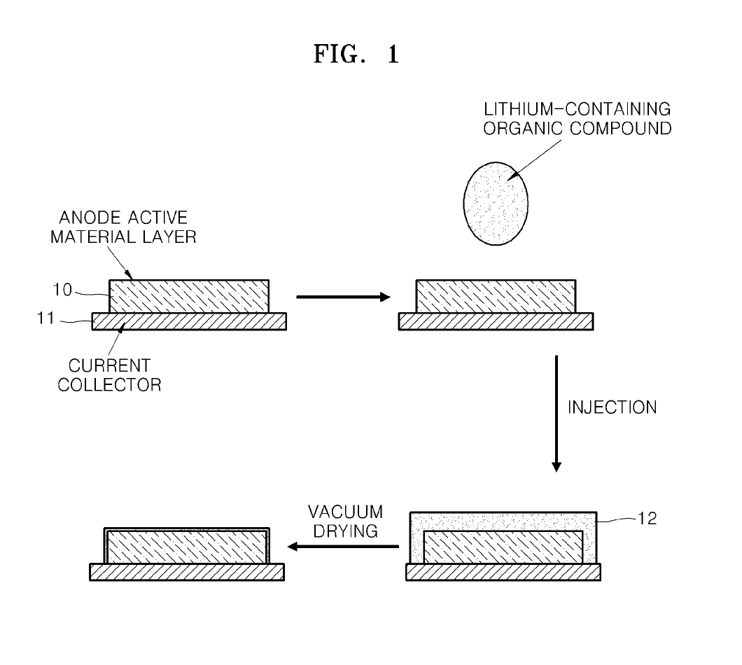

FIG. 1 is a drawing schematically illustrating a method of manufacturing an anode, according to an embodiment. Illustrated in FIG. 1 are the anode active material later 10, the current collector 11, and a layer 12 of the lithium-containing organic compound on the anode active material.

Examples of an anode active material, a conductive material, and a binder used in a method of manufacturing an anode according to an embodiment may include above-described anode active material, a conductive material, and a binder.

The first solvent is not specifically limited, and examples of the first solvent include solvents that are generally used in preparing the anode active material layer. Representative solvents include N-methylpyrrolidone, alcohols such as methanol ethanol propanol butanol, acetone, and water.

The step of applying the anode active material mixture onto the current collector to form the anode active material layer may be performed by directly coating the anode active material mixture on the current collector, or casting the anode active material mixture onto a separate support, delaminating an anode active material film from the support, and laminating the anode active material film onto a copper current collector.

The surface-treating mixture may be prepared in the form of a solution including a lithium-containing organic compound and a second solvent, and a surface film may be formed by applying the surface-treating mixture onto the anode active material layer formed on the current collector, removing solvent from the surface-treating mixture, and drying the solvent-removed surface-treating mixture under vacuum. Such a surface film may be present continuously or discontinuously, and the surface film may be present on an outer portion of the anode active material layer. However, a part of the surface film may substantially the present on an inner portion of the anode active material layer, e.g., on an inner surface.

The vacuum drying process may be performed at a temperature from about 60° C. to about 300° C., specifically about 70° C. to about 250° C., for a time from about 0.1 hours to about 20 hours, specifically about one hour to about 10 hours. Within the foregoing ranges, batteries may have improved lifetime characteristics.

Examples of the second solvent may include: a chain-type carbonate such as dimethyl carbonate, ethylmethyl carbonate, diethyl carbonate and dipropyl carbonate; dimethoxy ethane; diethoxy ethane; a fatty acid ester derivative; a cyclic carbonate such as ethylene carbonate, propylene carbonate and butylene carbonate; gamma-butyrolactone; N-methylpyrrolidone; acetone; and water. The lithium-containing organic compound may be contained in an amount from about 0.1% by weight to about 20%, specifically about 0.5% by weight to about 10% by weight, more specifically about 1% by weight to about 5% by weight, based on a total weight of the surface-treating mixture, and such an amount is controlled so that the extent of forming the surface film may be controlled.

The lithium-containing organic compound may be contained in an amount from about 0.0001% by weight to about 3% by weight, e.g., in an amount from about 0.001% by weight to about 1% by weight, based on a total weight of the weight of an anode active material layer obtained by mixing an anode active material, a conductive material, a binder, and a first solvent, and drying the mixture. Such an amount is controlled so that the extent of forming the surface film, i.e., a content or a thickness, may be controlled.

The lithium-containing organic compound is selected based on the weight of an anode active material layer including an anode active material, a conductive material, and a binder, and it can be difficult to substantially measure the weight of the lithium-containing organic compound. However, it is possible to calculate the weight of the lithium-containing organic compound through relative measurement values. For instance, after a solution including about 0.5% by weight of the lithium-containing organic compound is put into a powder in which an anode active material powder and a graphite powder have been mixed in a ratio of about 6.3:2.7, the mixture of the solution and the mixed powder is dried at about 150° C. for about 20 hours to obtain about 0.083% by weight of the lithium-containing organic compound as an average weight, the mixture of the solution and the mixed powder is dried at about 120° C. for about 2 hours to obtain about 0.083% by weight of the lithium-containing organic compound as an average weight, and the mixture of the solution and the mixed powder is dried at about 80° C. for about 2 hours to obtain about 0.085% by weight of the lithium-containing organic compound as an average weight. If a solution of the lithium-containing organic compound is dried at about 120° C. to about 150° C. for about 20 hours, about 0% by weight of solvent remains. If about 0.375 mL of a solution having a content of about 0.5% by weight of the lithium-containing organic compound and a density of about 1.18 g/mL is added and the resulting combination dried at about 120° C. for about 2 hours, the content of the lithium-containing organic compound in the anode active material layer may be calculated by the following Formulas 1 and 2:

Content of the lithium-containing organic compound=[added amount of a solution including the lithium-containing organic compound]×[density of the solution including the lithium-containing organic compound]×[% by weight of the lithium-containing organic compound in the solution including the lithium-containing organic compound]×[% by weight of the dried lithium-containing organic compound] Formula 1

% by weight of the lithium-containing organic compound in the anode active material layer=[content of the lithium-containing organic compound]/[weight of the anode active material layer]×100% Formula 2

A lithium battery according to another aspect includes a cathode, an anode, and an electrolyte, wherein the anode may be the disclosed anode. The lithium battery according to an embodiment may be manufactured as follows:

First, an anode active material, a conductive material, a binder, and a first solvent are mixed to prepare an anode active material mixture, the anode active material mixture is directly coated on a current collector or cast onto a separate support, an anode active material film is delaminated from the support, and the delaminated anode active material film is laminated onto a copper current collector to form an anode active material layer. After forming the anode active material layer, a surface-treating mixture is applied onto the anode active material layer, and then the anode active material layer is dried under vacuum to obtain an anode plate. Here, examples of the first solvent may include N-methylpyrrolidone, acetone, water and the like. The anode active material, the conductive material, the binder and the first solvent may be contained in such amounts that they are ordinarily used in lithium batteries, the details of which can be determined by one of skill in the art without undue experimentation, and the amounts are not particularly limited. The surface-treating mixture may include the lithium-containing organic compound and a second solvent.

A cathode active material, a conductive material, a binder, and a solvent are mixed to prepare a cathode active material mixture. The cathode active material mixture is directly coated on an aluminum current collector, and the coated cathode active material mixture is dried to prepare a cathode plate. After the cathode active material mixture is cast onto a separate support to form a film, the film, which is delaminated from the support, is laminated onto the aluminum current collector so that a cathode plate may be manufactured.

Any suitable of lithium-containing metal oxides ordinarily used in the art may be used as the cathode active material without limitation. Examples of the lithium-containing metal oxides may include LiCoO₂, LiMnₓO₂ₓ, LiNiₓ₋₁MnₓO₂ₓ(x=1 or 2), LiNi_{1-x-y} CoₓMn_{y}O₂ (0≦x≦0.5, and 0≦y≦0.5), and the like. The cathode active material mixture may use a conductive material, binder, and solvent as is disclosed for the anode active material mixture. Here, the cathode active material, conductive material, binder, and solvent may be contained in such amounts that they are ordinarily used in lithium batteries, the details of which can be determined by one of skill in the art without undue experimentation.

In some cases, the cathode active material mixture and the anode active material mixture may additionally include a plasticizer so that pores may be formed in an inner part of an electrode plate.

The lithium battery according to an embodiment may additionally include a separator between the cathode and the anode. Any type of material that is ordinarily used as the separator in a lithium battery may be used. Particularly, materials having improved electrolyte-containing capabilities and low resistance values with respect to ion movements of an electrolyte may be used as the separator. For instance, the materials for the separator may be used in the form of a non-woven fabric or a woven fabric, and may comprise materials such as at least one of those selected from glass fiber, polyester, Teflon, polyethylene, polypropylene, and Polytetrafluoroethylene (“PTFE”). More specifically, windable separators made of materials such as polyethylene, polypropylene and the like are used in lithium ion batteries, and separators having improved capabilities of impregnating an organic electrolyte are used in lithium ion polymer batteries. Such separators may be manufactured according to the following method:

Namely, a polymer resin, a filler, and a solvent are mixed to prepare a separator composition, the separator composition is directly coated on a top of an electrode and dried to form a separator film, or after the separator composition is cast on a support and dried, a separator film delaminated from the support is laminated on the top of the electrode to form the separator film.

The polymer resin is not particularly limited, and any suitable type of material used in a binder of the electrode plate may be used as the polymer resin. Examples of the polymer resin may include at least one selected from vinylidene fluoride/hexafluoropropylene copolymer, polyvinylidene fluoride (“PVDF”), polyacrylonitrile, and polymethyl methacrylate. Particularly, the examples of the polymer resin may include vinylidene fluoride/hexafluoropropylene copolymer containing about 8% by weight to about 25% by weight of hexafluoropropylene.

As is further described above, a separator is interposed between a cathode plate and an anode plate to form a battery structure. After the battery structure is wound or folded to be put into a cylindrical battery case or a rectangular battery case, an organic electrolyte is added, e.g., injected, into the battery structure in the battery case to complete a lithium ion battery. Alternatively, after the battery structure is laminated in a bicell structure, the bicell is impregnated with an organic electrolyte, the resulting product is put into a pouch, and the pouch is sealed to complete a lithium ion polymer battery.

The organic electrolyte may include a lithium salt and a mixed organic solvent comprising a high dielectric solvent and a low boiling point solvent, and may additionally include various additives such as an overcharge preventing agent if desired.

As the high dielectric solvent used in the organic electrolyte, any suitable type of material ordinarily used in the related art may be used. Examples of the high dielectric solvent may include cyclic carbonates such as ethylene carbonate, propylene carbonate and butylene carbonate, or gamma-butyrolactone, and the like.

Further, as the low boiling point solvent any suitable type of material ordinarily used in the related art may be used. Examples of the low boiling point solvent may include, but are not particularly limited to, chain-type carbonates such as dimethyl carbonate, ethylmethyl carbonate, diethyl carbonate and dipropyl carbonate, dimethoxy ethane, diethoxy ethane, or fatty acid ester derivatives, and the like.

The high dielectric solvent and the low boiling point solvent may each independently be unsubstituted or substituted with a halogen atom, and examples of the halogen atom may include fluorine.

The high dielectric solvent and the low boiling point solvent may be mixed in a volume ratio from about 1:1 to about 1:9, and lithium batteries may have improved discharge capacities and charging-discharging lifetime characteristics within this volume ratio range.

Further, any suitable type of lithium salts generally used in the art may be used in the organic electrolyte, and examples of the lithium salts may be at least one compound selected from LiCIO₄, LiCF₃SO₂, LiPF₆, LiN(CF₃SO₂)₂, LiBF₄, LiC(CF₃SO₂)₃, and LiN(C₂F₅SO₂)₂.

A concentration of the lithium salt in the organic electrolyte may be from about 0.5 M to about 2 M. When the concentration of the lithium salt in the organic electrolyte is within the foregoing concentration range, the organic electrolyte has an improved conductivity, and the mobility of lithium ions may be improved.

The lithium battery according to an embodiment has a high possibility of application in a micro battery for power supply of portable devices such as personal digital assistants (“PDA”s) and portable multimedia players (“PMP”s), a power supply for a driving motor of a hybrid automobile or an electric automobile, a power supply of a flexible display device such as e-ink, e-paper, flexible liquid crystal displays (“LCD”s) and flexible organic light-emitting diodes (“OLED”) displays, and power supply of integrated circuit devices on future printed circuit boards.

Hereinafter, examples will be described in detail. However, the embodiments are not limited to the examples.

### EXAMPLES

### Preparation Example 1

### Preparation of Composite Anode Active Material

After 20 grams (g) of silicon metal powder (from Kojundo Chemical Laboratory Co., Ltd., 4 micrometers (μm)), 100 g of butanol, 200 g of zirconia (ZrO₂) balls were put into a sealed container made of zirconia and an inner part of the sealed container was filled with an inert atmosphere, the resulting mixture was milled by a planetary mono mill manufactured by Fritsch Corporation during a process of 20 cycles including 30-minute milling and one hour break to obtain silicon metal powder having an average particle diameter of less than 500 nm. After 1.15 g of the silicon powder and 0.85 g of carbon nanotubes (source: carbon nanotube, CTUBE-120) were mixed in a mortar for one hour, the mixture together with 21 g of six steel balls was put into a sealed container made of hardened steel and an inner part of the sealed container was filled with argon gas. Then, the mixture was milled by a Model 8000M mixer/mill manufactured by SPEX CertiPrep Ltd (USA) for 60 minutes to prepare a Si-CNT composite anode active material.

### Example 1

After 0.63 g of the Si-CNT composite anode active material powder prepared in the Preparation Example 1 and 0.27 g of graphite powder were mixed with a polyamide imide (“PAI”) 6.5 wt % solution (solvent:N-methylpyrrolidone) in a weight ratio of 9:1, the mixture was stirred using a mechanical stirrer to prepare a slurry. After the slurry was coated onto a copper (Cu) current collector to a thickness of 100 μm using a doctor blade and the coated slurry was dried, the dried slurry was dried once again under conditions of vacuum and 200° C. to manufacture an anode plate.

After 2.5 g of polyacrylic acid and 0.83 g of LiOH were dissolved into 496.67 ml of water, the mixed solution was stirred at 60° C. for 24 hours to prepare 0.5% by weight of a lithium-containing organic compound solution. After the solution was injected into a surface of an electrode in an amount of 0.20 mL per 1 cm² area of the electrode, vacuum was used at room temperature so that the solution permeated into the electrode, and water was removed. Thereafter, the solution-permeated electrode was dried at 120° C. in a vacuum oven for 2 hours to finally manufacture an anode.

### Example 2

An anode was manufactured in the same manner as in Example 1 except that 2.5 g of polyvinyl alcohol procured from Sigma-Aldrich Corporation instead of 2.5 g of polyacrylic acid was used.

### Example 3

An anode was manufactured in the same manner as in Example 1 except that a mixture of polyacrylic acid and polyvinyl alcohol which had been mixed in a weight ratio of 5:5 was used in the amount of 2.5 g.

### Example 4

An anode was manufactured in the same manner as in Example 1 except that a mixture of polyacrylic acid and polyvinyl alcohol which had been mixed in a weight ratio of 3:7 was used in the amount of 2.5 g.

### Comparative Example 1

After 0.63 g of the Si-CNT composite anode active material powder and 0.27 g of graphite powder were mixed with a PAI 6.5 wt % solution (solvent:N-methylpyrrolidone) in a weight ratio of 9:1, the mixture was stirred using a mechanical stirrer to prepare a slurry. After the slurry was coated onto a Cu current collector to a thickness of 100 μm using a doctor blade and the coated slurry was dried, the dried slurry was dried once again under conditions of vacuum and 200° C. to manufacture an anode plate.

Battery Assembly

Using the anode plates manufactured in Examples 1 to 4 and Comparative Example 1, lithium metal as a counter electrode, a polyethylene (PE) separator, and a solution in which 1.3 M LiPF₆ had been dissolved into ethylene carbonate (EC), diethyl carbonate (DEC) and fluoroethylene carbonate (FEC) in a volume ratio of 2:6:2 as an electrolyte, type 2032 coin cell batteries were manufactured.

### Test Example 1

In the anode of Example 1, a weight of an anode active material layer was a total weight of an anode active material and a conductive material, and a weight of the anode active material layer was 30 mg. After a lithium-containing polyacrylic acid solution was put into anode active material powder in which anode composite active material powder and graphite powder had been mixed in a ratio of 6.3:2.7, the mixed solution was dried at 120° C. for 2 hours. After 3.8 mL of a solution including 0% by weight of water which was dried at 120 to 150° C. for 20 hours as solvent of the lithium-containing organic compound solution and including 0.54% by weight of lithium-containing polyacrylic acid solids, and having a density of 1.18 g/mL was injected into an anode active material layer, and dried at 120° C. for 2 hours, a lithium-containing organic compound weight in an anode active material layer weight was calculated from the following Formulas 1 and 2:

Content of lithium-containing organic compound=[added amount of lithium-containing organic compound solution]×[density of lithium-containing organic compound solution]×[% by weight of lithium-containing organic compound in lithium-containing organic compound solution] Formula 1

That is, a content of the lithium-containing organic compound=[3.8]×[1.18]×[0.0054]=[0.024] mg

by weight of the lithium-containing organic compound in the anode active material layer=[content of the lithium-containing organic compound]/[weight of the anode active material layer]×100% Formula 2%

That is, the percent (%) by weight of the lithium-containing organic compound in the anode active material layer=[0.024 mg]/[30 mg]×100=0.08% by weight.

### Test Example 2

Evaluation of charging and discharging was conducted as follows:

Constant current charging of the electrode was performed to 0.01 V at a current rate of 100 milliamperes (mA) per 1 g of active material. After a charging-completed cell passed through a break time of 10 minutes, constant current discharging of the charging-completed cell was performed at a current rate of 100 mA per 1 g of the active material until the voltage became 1.5 V.

Evaluations of charging and discharging were measured at the current rate of 150 mA per 1 g of the active material during the first and second charging-discharging cycles, and evaluations of charging and discharging were repeatedly measured at a current rate of 750 mA per 1 g of the electrode active material from the third charging-discharging cycle to the fiftieth charging-discharging cycle.

Capacity retention (%) and average cycle efficiencies after the charging-discharging cycles were obtained when repeatedly measuring 50 charging-discharging cycles at the current rate of 750 mA per 1 g of the electrode active material.

Discharge capacity was divided by charge capacity to calculate initial efficiency (%) in the first charging-discharging cycle, and fiftieth cycle efficiency (%) was divided by the initial efficiency (%) to calculate a capacity retention after performing the fiftieth charging-discharging cycle, and measurement results were recorded in the following Table 1:

TABLE 1

| | | | Capacity retention (%) |
|---|---|---|---|
| | | Initial | after fiftieth charging- |
| | Material | efficiency (%) | discharging cycle |
| Comparative | Non-treatment | 77.6 | 77.9 |
| Example 1 | | | |
| Example 1 | Li-PAA | 79.3 | 89.4 |
| Example 2 | Li-PVA | 80.6 | 90.2 |
| Example 3 | Li-(PAA:PVA = | 80.1 | 91.6 |
| | 5:5) | | |
| Example 4 | Li-(PAA:PVA = | 80.3 | 94.1 |
| | 3:7) | | |

It can be seen from results in Table 1 that initial efficiencies and cycle lifetime characteristics of the batteries may be improved by forming a surface film on anode active material layers using a lithium-containing organic compound. When comparing charging-discharging test results of the Comparative Example and Examples, it can be seen that initial efficiencies and cycle lifetime characteristics of batteries having surface-treated electrodes are more improved than those of batteries having non-surface treated electrodes. Such effects of improving the initial efficiencies and cycle lifetime characteristics of the batteries are thought to be obtained since the lithium-containing organic compounds not only suppress side reactions of anode active materials and electrolytes and improve binding power between anode active material particles, but also supplement conductivities of the anode active materials and prevent volume expansion of the anode active materials.

As described above, according to the one or more of the above embodiments, the anodes may improve an initial coulombic efficiency and cycle lifetime characteristics of the batteries because the surface of an anode active material layer is surface-treated with a lithium-containing organic compound.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. An anode comprising:
a current collector;
an anode active material layer disposed on the current collector; and
a lithium-containing organic compound disposed on a surface of the anode active material layer.

2. The anode of claim 1, wherein the lithium-containing organic compound comprises at least one organic compound selected from polyacrylic acid, polyvinyl alcohol, polymethyl methacrylate, and polyethylene glycol.

3. The anode of claim 1, wherein the lithium-containing organic compound is in a form of a film on the anode active material layer.

4. The anode of claim 1, wherein the lithium-containing organic compound is contained in an amount from about 0.0001% by weight to about 3% by weight, based on a total weight of the anode active material layer.

5. The anode of claim 1, wherein the anode active material layer comprises an anode active material, a conductive material, and a binder.

6. The anode of claim 5, wherein the anode active material is a carbonaceous anode active material, a metallic anode active material, or a composite thereof.

7. The anode of claim 5, wherein the anode active material is a silicon-carbon-composite or a tin-carbon composite.

8. The anode of claim 1, wherein the lithium-containing organic compound comprises about 0.01% by weight to about 20% by weight of lithium, based on the total weight of the lithium-containing organic compound.

9. A method of manufacturing an anode, the method comprising:
mixing an anode active material, a conductive material, a binder, and a first solvent to prepare an anode active material mixture;
applying the anode active material mixture onto a current collector to form an anode active material layer;
applying a surface-treating mixture onto the anode active material layer; and then
drying the anode active material layer under a vacuum, wherein the surface-treating mixture comprises a lithium-containing organic compound and a second solvent.

10. The method of claim 9, wherein the surface-treating mixture comprises about 0.01% by weight to 20% by weight of the lithium-containing organic compound, based on the total weight of the surface-treating mixture.

11. The method of claim 9, wherein the vacuum drying process is performed at a temperature from about 60° C.° C. to about 300° C. for a time period of about 0.1 hours to about 20 hours.

12. A lithium battery comprising a cathode, an anode, and an electrolyte,
wherein the anode is an anode according to claim 1.
